(19) United States
(12) Patent Application Publication
(10) Pub. No.: US 2007/0189488 A1
(43) Pub. Date: Aug. 16, 2007

(54) Method of providing improved Ringback Tone signaling

(76) Inventor: Daniel Stewart Stoops, Galena, OH (US)

Correspondence Address: Lucent Technologies Inc.;Docket Administrator, Room 3J-219, 101 Crawfords Corner Road, Holmdel, NJ, 07733-3030, US

(21) Appl. No.: 11/343,424

(22) Filed: Jan. 31, 2006

(51) Int. Cl. H04M 3/42

(52) U.S. Cl. 379/207.16

(57) ABSTRACT

The RingBack Tone song that a subscriber to a RingBack Tone service has selected to be played to callers instead of the traditional ringing is prepended with a personalized message from the subscriber so as to avoid confusing the called party who is expecting to hear ringing until the call is answered.

### TECHNICAL FIELD

The invention relates to telecommunications.

### BACKGROUND OF THE INVENTION

Several telecommunications service providers currently offer their subscribers a service known as “RingBack Tones.” RingBack Tones are the substitution of audio files for the normal ringing that is traditionally heard by a calling party while waiting for the called party to answer the phone. With RingBack Tones, a calling party instead hears a popular song that has been chosen by the subscribing called party while waiting for the off-hook event to occur.

RingBack Tones, however, can be confusing to the calling party because of the long history of the traditional ringing tone that a calling party is expecting to hear. Thus, when a calling party hears a song instead of traditional ringing, he or she is apt to confuse that audio with a failure to connect, having reached a wrong number, or a malfunction within the phone or phone network. In order to alleviate that concern, service providers have been prepending an audio file containing a standard announcement to the audio file containing the song so as to alert the calling party of the new feature that they are experiencing. Thus, the calling party may hear an audio file, such as “ABC Wireless offers you this music to listen to while we connect your call”, before the RingBack Tone audio file containing the song the subscriber has selected is played to the calling party.

An improved method of alerting the calling party that they are about to hear a RingBack Tone rather than the traditional ringing signaling is desired.

### SUMMARY OF THE INVENTION

In accordance with an embodiment of the present invention, the prepended announcement made to the calling party informing them that they are about to hear music that is played before the actual subscriber-selected RingBack Tone, is personalized to the called party/subscriber. In an embodiment, the prepended announcement identifies the called party/subscriber and may include the name of the called party in the called party/subscriber's own recorded voice. Alternatively, if an audio file containing the recorded name in the called party/subscriber's own voice is not available, then a text-to-speech rendition of that name is used in the prepended preamble announcement. The called party/subscriber's name, whether it be pre-recorded or converted from text-to-speech, is integrated into a standard message and prepended to the RingBack Tone audio file containing the selected song and played to the calling party during call setup. The pre-recorded or text-to-speech created name is integrated into the standard alerting message by prepending it to a fixed message, by appending it to a fixed message, or inserting it between two parts of a standard message.

In an alternative embodiment, the subscriber creates an audio file containing an alerting message in it entirety in his or her own voice which is prepended to an audio file containing the selected RingBack Tone and played during call setup to a called party during the call setup period.

### BRIEF DESCRIPTION OF THE DRAWING

The present invention will be better understood from reading the following description of non-limiting embodiments, with reference to the attached drawings, wherein below:

FIG. 1 shows the format of a prior art RingBack Tone as originally offered to subscribers of a RingBack Tone service;

FIG. 2 shows the format of a prior art RingBack Tone as is currently being offered to subscribers of a RingBack Tone service;

FIG. 3 shows an improved format of a RingBack Tone in accordance with an embodiment of the present invention; and

FIG. 4 shows an exemplary network architecture for implementing an embodiment of the present invention.

### DETAILED DESCRIPTION

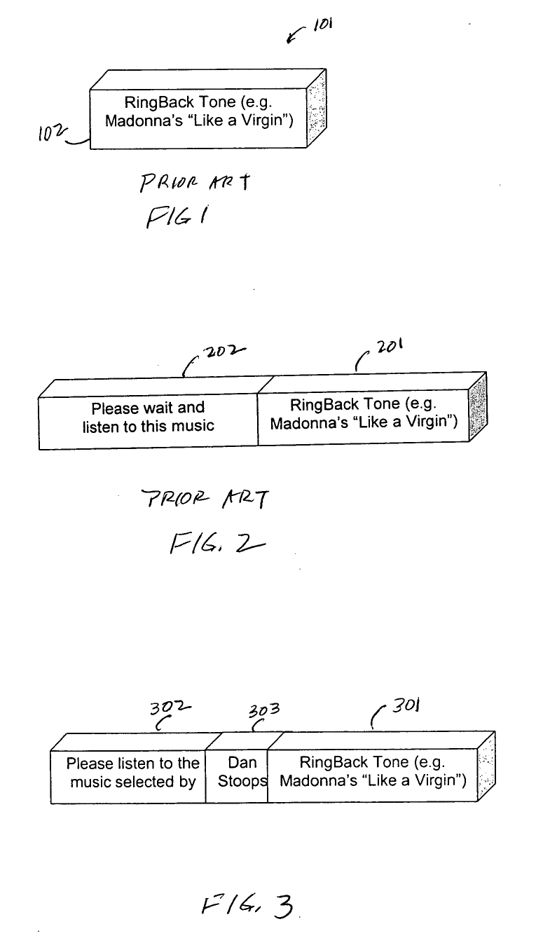

FIGS. 1-3 show the evolution of how the offering of RingBack Tones has evolved from its original offering by service providers to its customers as shown in FIG. 1, how it was improved by service providers to avoid caller confusion as shown in FIG. 2, and how an embodiment of the present invention improves it further. As originally offered, as shown in FIG. 1, the RingBack Tone 101 was simply an audio file 102 that was played to a calling party who has called a subscriber of the service. The subscriber, in electing to receive this service, selects a song he wants played to those who call him during the call setup period instead of the traditional ringback ringing sound that had been heard during call setup since the earliest days of telephone service. Subscribers to RingBack Tones service select the song they want played to their callers from a list of songs that the service provider has licensed for this purpose. The subscriber-selected RingBack Tone audio file 102, which is illustratively shown as being Madonna's “Like a Virgin”, is played to the calling party immediately after the called party's local switch establishes an audio connection with a RingBack server on which the RingBack Tone service resides, and which has stored in a database associated there with audio files containing the various song options available to subscribers of the service, an identification of each of the service provider's subscribers to the service, and for each subscriber, the identification of particular song that the subscriber has selected as his RingBack Tone. The subscriber, when signing up for the service may elect to have his selected RingBack Tone played to all callers, or only to select callers, identified by the called-from telephone number and identified by the RingBack server using ANI (automatic number identification).

As previously noted, the replacement of the normal ringing signal with a RingBack Tone consisting of only played music was often confusing to calling parties who were befuddled in hearing music when they expected to hear traditional ringing. Thus, as shown in FIG. 2, service providers modified their RingBack Tone service so as to prepend the subscriber's selected RingBack Tone 201 of the subscriber's selected song (e.g., Madonna's “Like a Virgin”) with a standard audio file 202 containing a phrase such as: “please wait and listen to this music.” The calling party, when hearing that preamble to the RingBack Tone, is alerted to the fact that he will be hearing music rather than the normal traditional ringing signal that he would otherwise hear during the call setup period.

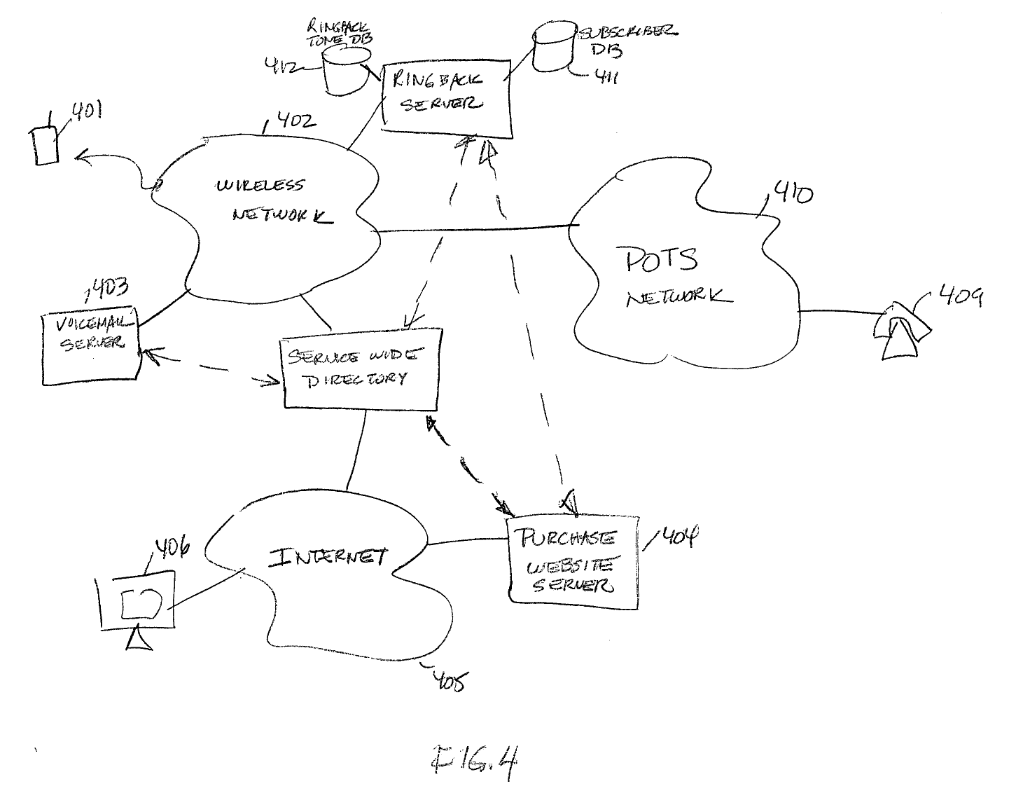

Embodiments of the present invention improve on the prior art in that they also provide to the calling party an indication of the identity of the called party as a preamble to the RingBack Tone. In an embodiment of the present invention, shown in FIG. 3, the audio file 301 containing the RingBack Tone (e.g., Madonna's “Like a Virgin”) selected by a subscriber is prepended with an audio file 302 that contains a standard announcement and a subscriber-specific audio file 303 that contains the name of the called party/subscriber. Thus, the standard announcement audio file 302 could say: “Please listen to the music selected by”, which is then followed by the subscriber-specific audio file 303 containing the name of the called party/subscriber (e.g., “Dan Stoops”). When audio files 302, 303 and 301 are combined in that order and played to the calling party, the calling party would thus hear: “Please listen to the music selected by Dan Stoops” followed by the RingBack Tone selected by the called party/subscriber. In this manner, the calling party is both made aware of the fact that he is about to hear music instead of the normal ringing signal, and is made aware that he has properly dialed the number of the party with whom he wants to speak. Other arrangements of audio files that prepend the subscriber-selected RingBack Tone can be made. For example, the audio file containing the name of the called party/subscriber could be played before an audio file containing a standard message so that the calling party would hear, for example, “Dan Stoops has selected this music” before the RingBack Tone is played. In another arrangement, the audio file containing the name of the called party/subscriber could be sandwiched between with two separate standard audio files. The user could thus hear, for example, “You are calling Dan Stoops. Please listen to this music while you wait.” The selected RingBack Tone would then follow.

The audio file containing the name of the called party/subscriber can be the actual recorded voice of the called party/subscriber obtained by the service provider in association with the provision of other services or collected when the subscriber has signs-up for the RingBack Tone service. As an example of the former, an audio file that contains the subscriber's recorded name can come from a Service Wide Directory that coordinates the service provider's voicemail systems. Currently, at most wireless service providers, voicemail penetration is in excess of 80%. The voicemail system implemented by most wireless service providers allows the subscriber to record their spoken name when they are establishing their voicemail service. This spoken name is used for addressing messages (e.g., your message to “Dan Stoops” has been sent), or retrieving messages (e.g., First new message from “Dan Stoops”). The recorded names of its subscribers can be made available to any application in the service provider's network using a centralized Service Wide Directory that exposes the recorded name as an attribute. The Service Wide Directory can also find recorded names from other services provided by the service provider.

The audio file containing the recorded name of the subscriber is stored on a RingBack server in association with subscriber's identity and the identity of the particular RingBack Tone the subscriber has selected. When an incoming call for the subscriber is received in the network, the RingBack server recognizes that the called party is a subscriber to the RingBack Tone service and retrieves the recorded name and the identity of the selected RingBack Tone associated with that subscriber. The subscriber's recorded name is then combined with the standard audio file to create a composite file that is played before the selected RingBack Tone, the latter being retrieved by the RingBack Server from its library of stored RingBack Tones.

If the Service Wide Directory cannot find the actual recorded name of the called party/subscriber anywhere on the service provider's network, then an audio file containing the name of the subscriber is synthesized using standard text-to-speech processing from a text name associated with the subscriber's account. That audio file containing the synthesized name is then stored by the RingBack server in association with the subscriber's identity and the identity of the selected RingBack Tone, and is used to generate the personalized message that prepends the RingBack Tone.

Alternatively, depending on how the RingTone Service is established, the subscriber can be asked to call a special number when he registers for the service, enter an identification number, and then state his name so as to create a file that is stored by the RingBack server in association with the subscriber's identity and the identity of the selected RingBack Tone. Even further, rather than combining the recorded name of the subscriber with standard message components to form the audio message that prepends the RingBack Tone, the subscriber during the registration process can be asked to call a special number, enter an identification number, and then repeat the desired phrase that he wants to prepend playback of his selected RingBack Tone. That phrase would then be stored in an audio file by the RingBack server in association with the subscriber's identity and the identity of the selected RingBack Tone, and played before the selected RingBack tone is played to callers during call setup. The subscriber could then rely on the calling party recognizing his voice as personalizing the appended message. As an example, the message could simply say: “Dan brings you this music.”

FIG. 4 is shows an embodiment of a network architecture for providing a personalized RingBack Tone service. In this embodiment, the subscriber/called party is illustratively shown as being a wireless subscriber, where his wireless service provider supports the RingBack Tone service. It should be understood, however, that the RingBack Tone service could also be provided to a telephone subscriber who is connected to the POTS network. The subscriber at mobile terminal 401, connected to his service provider's wireless network 402, records his name with his service provider's voicemail server 403 when setting up his voicemail account. When the subscriber decides to subscribe to the RingBack Tone service offered by the service provider, he logs onto the service provider's Purchase Web site 404 over the Internet 405 through his PC 406, which is running an HTML browser. While browsing at the purchase Web site 404 with his PC 406, the subscriber selects which specific song from among a plurality of offered songs he wants callers to his mobile terminal's number to hear during the call setup time rather than the traditional and historical ringback. The subscriber will also decide whether he wants the selected RingBack Tone to be played for each incoming call or only to calls that originate from telephone numbers that the subscriber specifies.

Once the subscriber has completed the purchase process at the Purchase Website 404, the Purchase Website 404 contacts the service provider's Service Wide Directory 407 (shown by dotted connection there between) and the service provider's RingBack server 408 (shown by dotted connection there between), which are each connected to the wireless network 402. The RingBack server 408 creates a record in its database 411 indicating the subscriber's identity, his mobile terminal's phone number and EIN, and the identity of the particular RingBack Tone song the subscriber has selected, where the audio files containing the RingBack Tone songs are stored in an associated database 412. The Service Wide Directory 407 retrieves from Voicemail server 403, the audio file containing the subscriber's recorded name and provides that file to RingBack server 408, where that audio file is also stored in association with the subscriber's identity in database 411. If the Service Wide Directory 407 is unable to retrieve a voice file containing the subscriber's recorded voice from the Voicemail server 403, it then converts the text of the subscriber's name to an audio file and sends that file to RingBack server 408 where that file is stored in association with the subscriber's identity in database 411.

As previously described, the subscriber alternatively could be directed to call a specified number from his mobile terminal 401 after making the purchase through the Purchase Website 404. The subscriber would be asked to verbally state his name, or alternatively recite a desired preamble to the Ringback Tone. An audio file is created, which is stored in database 411 in association with the subscriber's identity.

When a calling party at an exemplary illustrated hard-wired terminal 409 places a telephone call through the POTS network 410 to mobile terminal 401, network signaling reaches wireless network 402 where RingBack server 408 recognizes mobile terminal 401 as being subscribed to the RingBack Tone service. Rather than returning the traditional ringback to the called party, RingBack server 408 provides the subscriber-selected RingBack Tone, which is prepended with the customized preamble. Specifically, when RingBack server 408 recognizes an incoming call as being directed to a subscriber of the service, it retrieves the subscriber's file from database 411 to determine the identity of the RingBack Tone the subscriber has selected, the stored audio file containing the subscriber's name (or depending on the embodiment, the entire preamble phrase the subscriber has recorded). RingBack server 408 then prepends playing of the selected RingBack Tone (retrieved from database 412) with the combination of the recorded name (retrieved from database 411) and the other standard preamble components (retrieved from database 412 or stored internally by RingBack server 408) that together make up the personalized preamble message. Alternatively, audio file containing the entire preamble phrase recorded by the subscriber is retrieved from database 411 and played before the selected RingBack Tone. The subscriber-personalized preamble message and the selected RingBack Tone are then successively transmitted on the voice circuit back to the calling party at terminal 409 until the subscriber at mobile terminal 401 answers the incoming call.

The preceding merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagram herein represents a conceptual view illustrating the principles of the invention. Similarly, it will be appreciated that the various processes described may be substantially represented in computer readable medium and so executed by a computer or processor, whether or not such computer or processor is explicitly shown.

The functions of the various elements shown in the FIG. 4, including functional blocks labeled as “servers” may be provided through the use of dedicated hardware as well as hardware capable of executing software in association with appropriate software.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

The invention claimed is:

1. A method during a call setup between a calling party and a called party subscriber comprising:
sending music that has been selected by the subscriber instead of ringing during the call setup between the calling party and the subscriber:
characterized in the step of:
prepending to the selected music an announcement that is personalized to the subscriber.

2. The method of claim 1 wherein the announcement that is prepended to the music includes the subscriber's name.

3. The method of claim 2 wherein the subscriber's name is in a recorded voice of the subscriber.

4. The method of claim 2 wherein the subscriber's name is in a voice that has been converted to a speech signal from a stored text representation of the subscriber's name.

5. The method of claim 1 wherein the announcement is in the voice of the subscriber.

6. A method during a call setup between a calling party and a called party subscriber comprising:
receiving music that has been selected by the subscriber instead of ringing during the call setup between the calling party and the subscriber:
characterized in that:
the selected music is prepended with an announcement that is personalized to the subscriber.

7. The method of claim 6 wherein the announcement that is prepended to the music includes the subscriber's name.

8. The method of claim 7 wherein the subscriber's name is in a recorded voice of the subscriber.

9. The method of claim 7 wherein the subscriber's name is in a voice that has been converted to speech from a text representation of the subscriber's name.

10. The method of claim 6 wherein the announcement is in the voice of the subscriber.
